(19) United States
(12) Patent Application Publication
(10) Pub. No.: US 2014/0252846 A1
(43) Pub. Date: Sep. 11, 2014

(54) POLYGONAL HUB FOR FULLY FLOATING REAR DRIVE AXLE OF A VEHICLE

(71) Applicant: MAHINDRA NAVISTAR AUTOMTIVES LIMITED, A COMPANY REGISTERED UNDER THE PROVISION OF INDIAN COMPANIES, Mumbai, Maharashtra (IN)

(72) Inventor: Arvind Hanamant Sawant, Worli (IN)

(21) Appl. No.: 14/350,680

(22) PCT Filed: Oct. 10, 2012
(86) PCT No.: PCT/IN2012/000673

§ 371 Date: Apr. 9, 2014

(30) Foreign Application Priority Data
Oct. 11, 2011 (IN) 2871/MUM/2011

(51) Int. Cl. B60B 27/02

(52) U.S. Cl. CPC B60B 27/02
USPC 301/105.1

(57) ABSTRACT

A polygonal hub for fully floating rear drive axle of a vehicle used in the break drum and wheel assembly comprising a hub (4) which rotates on the supporting member (10) of axle drive shaft assembled with inner bearing (5) and outer bearing (7) in the housing therein to enable to rotate freely about an axis and are fixed in position with the member (10); the complete wheel end assembly is then packed with lock nut (12). The hub having a flange (15) carries wheel bolt (2) which provides seating for brake drum (1) and wheel rim and tightened with the use of wheel nut (3). The hub (4) is formed by casting. An embodiment provides a hexagonal shape to the central portion instead of circular shape of the hub.

### FIELD OF INVENTION

The present invention is related to wheel hubs used on fully floating rear drive axle of a vehicle. More particularly the present invention is related to polygonal hub for a vehicle for any application which is with optimum material content and achieves more strength to weight ratio.

### BACKGROUND OF THE PRESENT INVENTION

Hubs are mounted on the axle housing spindle through locking arrangement assembled with bearings and seals. The hub lies between drive gearing and wheel end parts like rims, brake drums and tires. The basic functions of axle hub are,
to support the vehicle dead weight acting on the track point with other loads i.e. cornering loads, breaking loads and traction torque loads,
to provide the mounting interface for wheel rims, brake drums and ABS accessories,
to enclose the sub assembly parts like bearings, seals, shims, locking accessories and grease.

Axle hubs primarily in circular in shape made of casting material. But these hubs are subjected to below mentioned loads effective in different directions during the vehicle operations;
Torque loads due to torque transmission at axle shaft joint
Vertical load due to dead weight
Braking load
Transverse load due to cornering and kerb strike

The existing axle hub design methodology is generally based on following factors:
1. The outer shape of the hub is circular with maximum section thickness to achieve the maximum strength.
2. Vertical solid ribs are used to achieve the required stiffness without any deflection.
3. Inner elliptical shape covered with outer circular section to achieve the strength.
4. Bridge like structure between to bearings to achieve the strength in all vehicle loading condition
5. Field experience of the available designs

Due to these conventional design factors, the existing hubs are not optimal as;
The hubs are heavier due to maximum material content in circular shape in load line area (i.e. track point).
These hubs are having less strength to weight ratio
Cooling area is not optimal

To achieve the required strength and stiffness characteristics, of the hub, the hub designers are using more material which leads to increase in weight of hub for the application having lower strength to weight ratio. The prior art concepts of hub are not optimally stiff enough but are voluminous and hence heavy.

Japanese patent JP2003285603A discloses circular hub with elliptical shaped central cavity in casting which will provide the required stiffness and strength. But apart from strength, these hubs are voluminous and hence carry more loads. These hubs behave in similar way as circular shaped hubs. But the main drawback of this design is that the frontal portion is covered with bigger outer circular shape having maximum section modulus and more strength than the rear portion of the hub (i.e. back side of the flange) causing the stress concentration in this region.

Korean patent KR20090050233A describes circular shaped hub with additional triangular ribs provided in bolt area. This will provide the more stiffness to the flange area which will be beneficial in cornering and vertical loading to avoid the deflection. But as the central portion of the hub is circular these hubs have always less strength to weight ratio.

### Objectives of the Present Invention

The main object of the present invention is to provide wheel hub of polygon structure and more particularly the hexagon structure.

Another object of the present invention is to provide hexagonal hub that achieves the maximum strength with optimized material content.

Another object of the present invention is to provide hexagonal hub that achieves the more part life with lower material content having more strength to weight ratio.

### Statement Of Invention

Accordingly invention provides a polygonal hub for fully floating rear drive axle of a vehicle of used in the break drum and wheel assembly comprising a hub which rotates on the supporting member of axle drive shaft assembled with inner bearing and outer bearing in the in the housing therein with seals lubricants to enable rotate freely about an axis and are fixed in position with the said member; the complete wheel end assembly then packed with lock nut; the said hub having a flange carries wheel bolt which provides seating for brake drum and wheel rim and tightened with the use of wheel nut; the said hub is formed by casting having central portion, which is the main portion of hub, characterized in that the said central portion is made of hexagonal in shape to carry safely the various loads (i.e. vehicle GVW, cornering, braking & torque load) during different operating conditions of the wheel.

### BRIEF DESCRIPTION OF THE FIGURES

The present invention will lead to better understanding when read in conjunction with the following drawings, wherein

FIG. 1 shows isometric view of the polygonal (hexagonal) hub in accordance with the present invention.

FIG. 2 shows sectional view showing position of the hub of the present invention fitted on live axle.

FIG. 3 shows front view of the hub showing the hexagon structure in accordance with the present invention.

FIG. 4 shows cut section of the hub showing the hexagon structure at load line as per the present invention.

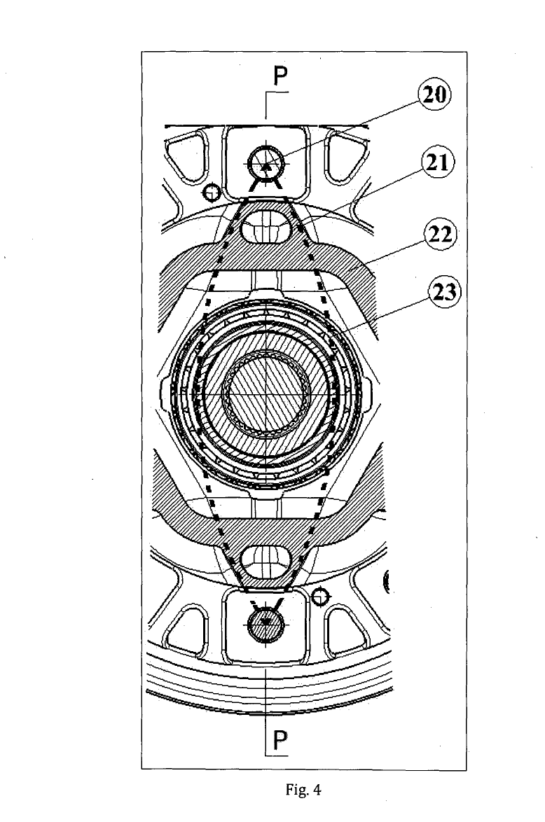

FIG. 5 shows torque reaction cancellation due to hexagon structure as per the present invention.

FIG. 6 shows stress plot for vertical bump load case analyzed through CAE for existing and hexagonal hub of the present invention.

FIG. 7 shows stress plot for kerb strike load case analyzed through CAE for existing and hexagonal hub of the present invention.

FIG. 8 shows stress plot for cornering load case analyzed through CAE for existing and hexagonal hub of the present invention.

FIG. 9 shows stress plot for pot hole load case analyzed through CAE for existing and hexagonal hub of the present invention.

FIG. 10 shows stress plot for torque load case analyzed through CAE for existing and hexagonal hub of the present invention.

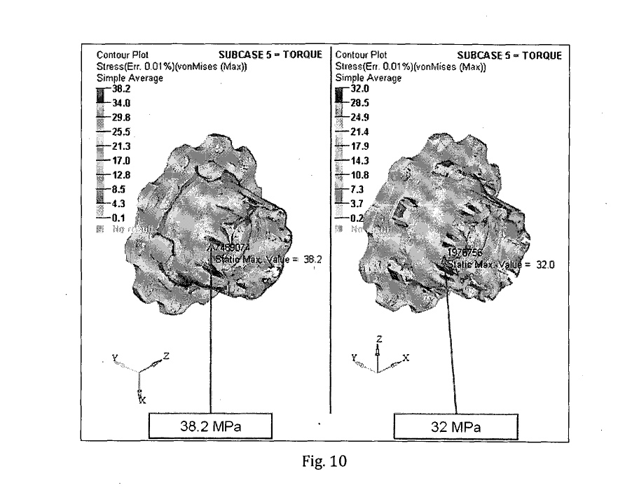

### DETAILED DESCRIPTION OF THE PRESENT INVENTION

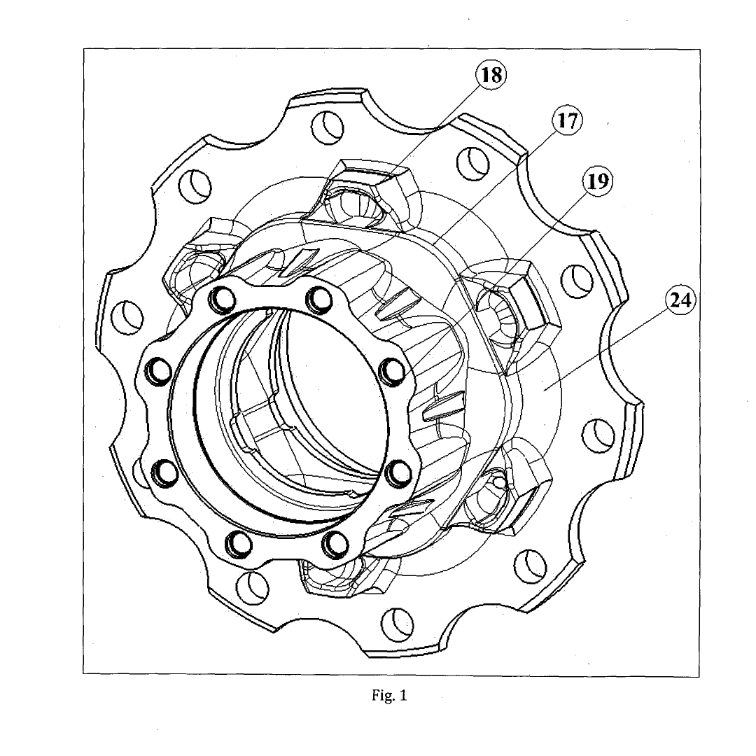

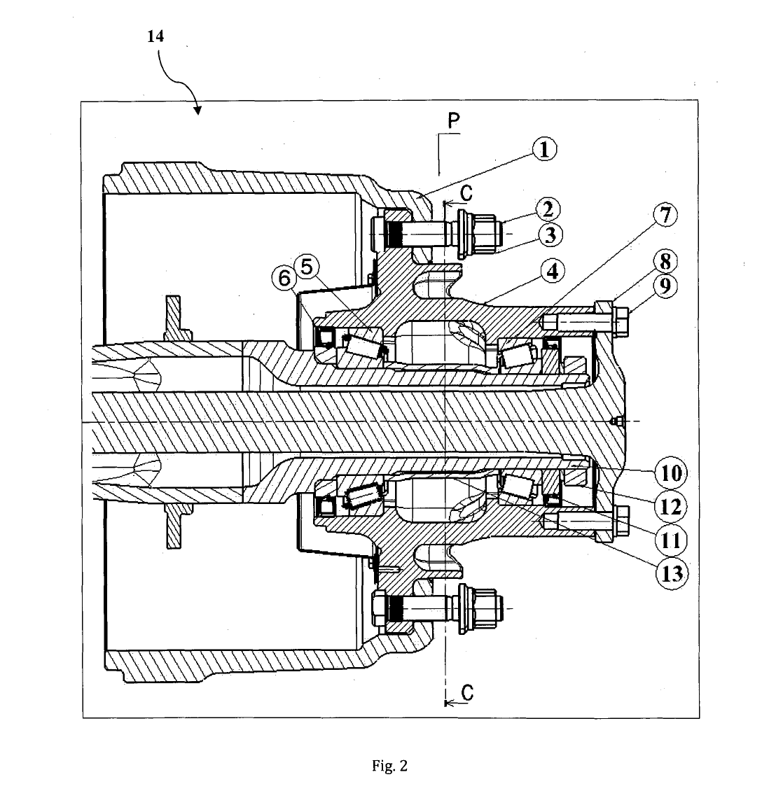

Referring to FIGS. 1 and 2, hub assembly (14) of the present innovation couples the wheel of a vehicle (not shown) and brake drum (1) of a vehicle, assembled on the full floating axle. The suspension system (not shown) is mounted on the axle housing through U bolts, which generally moves vertically on the vehicle against the bias of the spring. In case of front wheel, the hub is mounted on the steering knuckle (not shown) and helps for vehicle maneuverability.

The hub assembly (14) comprises of hub (4) which rotates on the member (10) assembled with inner bearing (5) and outer bearing (7). These bearing help to rotate about an axis and are fixed in position with member (10). This complete wheel end assembly is then packed with lock nut (12). The axle hub (4) serves as housing for bearings (5 & 7), seals (6 & 11) and lubrication media. The hub flange (15) carries wheel bolt (2) which provides seating for brake drum (1) and wheel rim and tightened with the use of wheel nut (3). The hub (4) is formed by casting.

Referring to FIG. 1, the central portion (17), which is the main portion of hub (4), is hexagonal in shape and carries the various loads (i.e. vehicle GVW, cornering, braking & torque load) during different operating conditions of the wheel. This hexagonal profile of the hub has technical advantages over the circular profile, as the hexagonal section has higher section modulus than that of the same size of circular section. As per theoretical calculation based upon the section modulus, hexagonal section (17) carries 10% more strength than the similar circular section used in the load line area. Thus, the smaller hexagon (18) joins the central hexagon (17) with hub flange (15), giving the required strength and stiffness. In the hub (4), portion (24) is very critical as this portion of the hub carries all vehicle loads. This area also prone to heat dissipated from brake drum.

The integrated hexagons (18) provide mesh like structure to increase the hub stiffness with minimum mass content. This mesh like structure is formed due to load lines (23) which transfer and cancel the loads, reducing loads and stress intensity in this area. The intersecting hexagon edge (21) is so arranged that they are parallel to central hexagon from two sides (22). During vertical loading (load ‘P’) the face to face intersecting hexagon forms elliptical shaped load line (23), reducing the concentrating loading in the hub. Thus, the main central hexagon with intersecting hexagons increases the strength of hub assembly by 10% more than that of the circular hub.

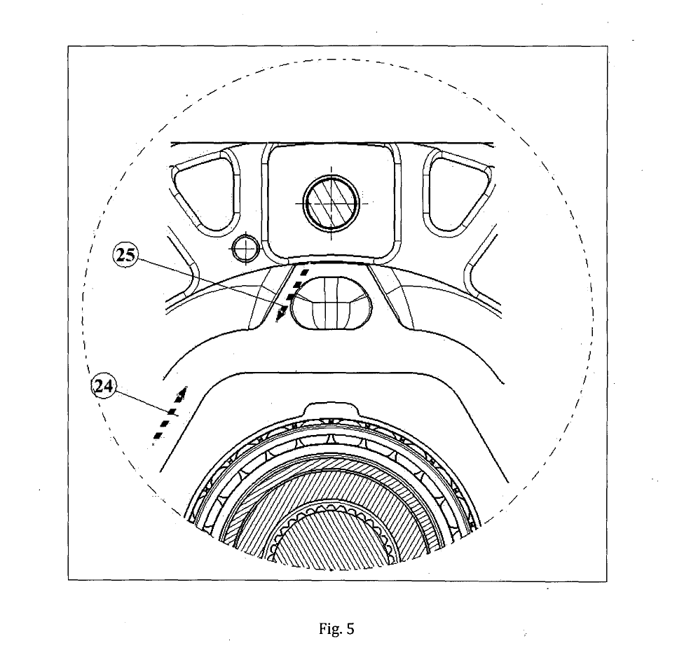

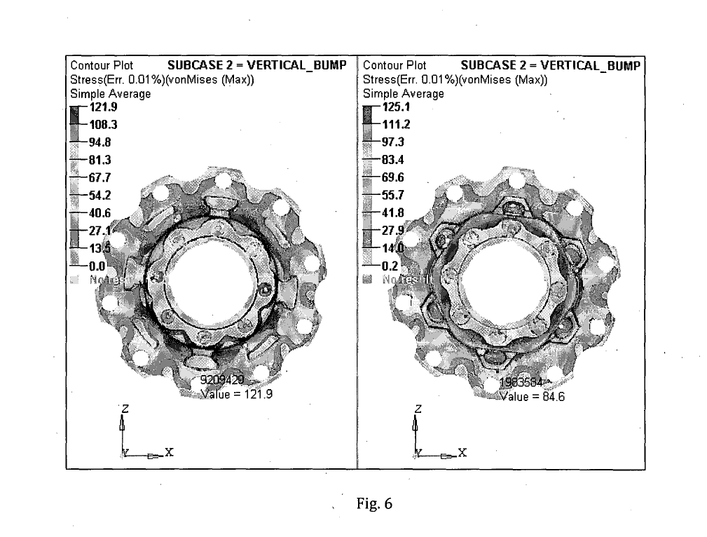

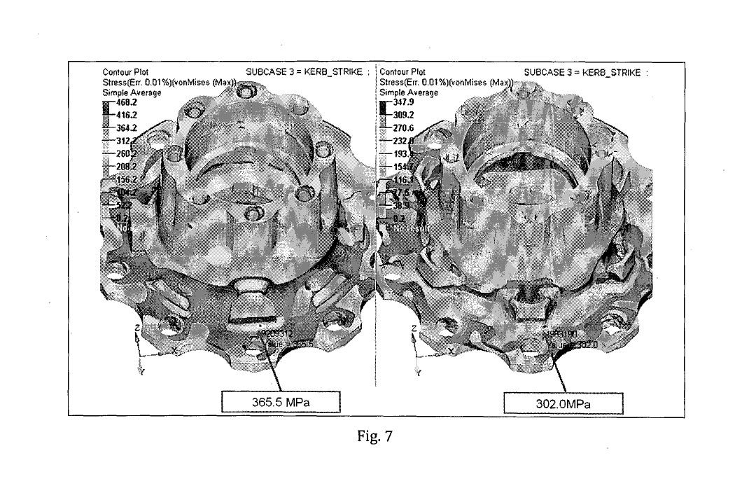

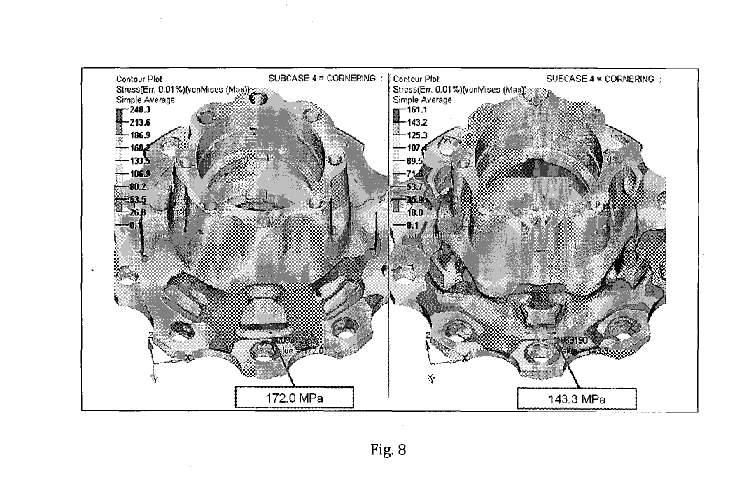

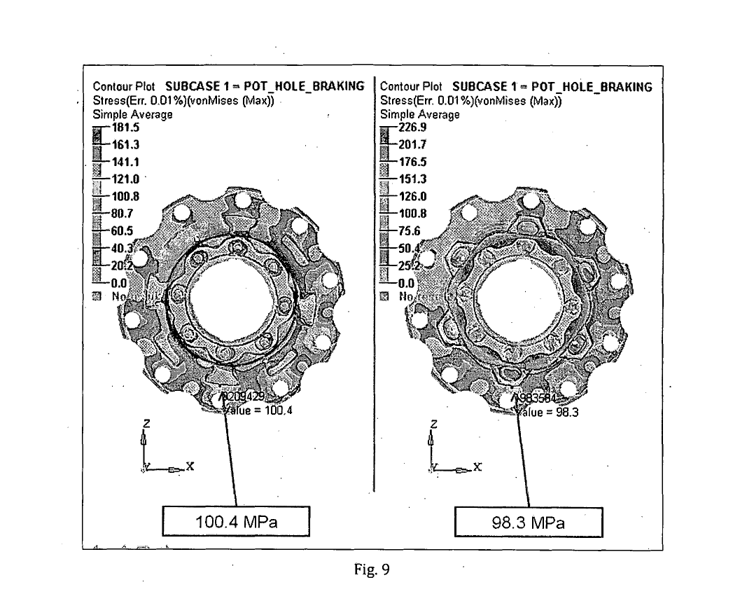

Also the intersecting hexagons are cancelling torque reactions created due to axle shaft (8), which is coupled with hub through the flange bolt (9). The axle shaft (8) transfer the torque loads received from vehicle driveline, which is transferred to wheels through the hub. Referring to FIG. 5, due to intersecting structure, the torque reactions (24 and 25) are getting reduced where as the mass content in joinery area of central hexagon (17) and axle shaft receiving area (19) is optimized. As tested through CAE analysis, FIGS. 6, 7, 8, 9 & 10 shows the stress pattern for the hexagonal hub as compared to the circular hub for various load cases with same load magnitude producing reduced stress in new hub with optimal material content. The comparative stress data for hexagonal hub compared to the circular hub is presented in the following table.

NEW HUB DESIGN

| | | Existing | Hub-NGHEX | % Reduction |
|---|---|---|---|---|
| 1G = RAW/2 | 6.2 | Stress | Stress | in |
| 1G = RAW/2 | 6.2 | (Mpa) | (Mpa) | stress |
| Vertical bumb | | | | |
| x (Ton) | 0.0 | 121.9 | 84.6 | 44% |
| y (Ton) | 0.0 | | | |
| z (Ton) | 18.5 | | | |
| Kerb strike | | | | |
| x (Ton) | 9.3 | 365.5 | 302 | 21% |
| y (Ton) | 9.3 | | | |
| z (Ton) | 9.3 | | | |
| Cornering | | | | |
| x (Ton) | 0.0 | 172 | 143.3 | 20% |
| y (Ton) | 5.3 | | | |
| z (Ton) | 10.7 | | | |
| Pot hole | | | | |
| x (Ton) | 8.7 | 100.4 | 98.3 | 2% |
| y (Ton) | 0.0 | | | |
| z (Ton) | 8.7 | | | |
| Torque | | | | |
| Torsional (N-mm) | 23500000 | 38.2 | 32 | 19% |

In addition to the significant reduction in the highest stress levels, experienced by hub (4), the location of stress levels is vastly improved using the hexagonal structure. The repositioning and reduced stress region in the hub is shown in FIG. 5. The resultant load vectors are distributed giving reduced stress levels and improved stiffness of the hub at optimized material content.

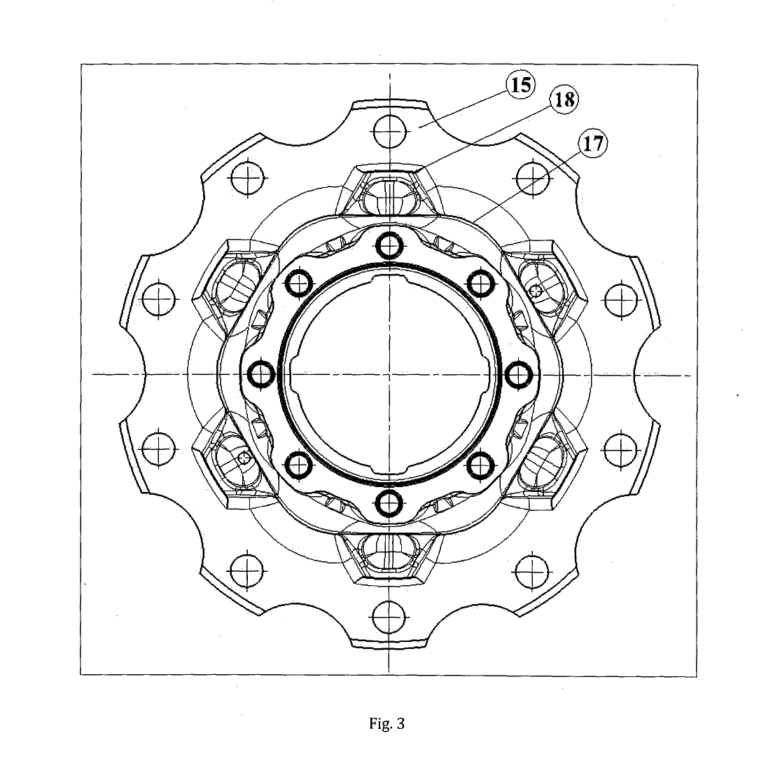

Thus a polygonal hub for fully floating rear drive axle of a vehicle used in the break drum and wheel assembly comprising a hub (4) which rotates on the supporting member (10) of axle drive shaft assembled with inner bearing (5) and outer bearing (7) in the in the housing therein with seals and lubricants to enable rotate freely about an axis and are fixed in position with the said member (10); the complete wheel end assembly is then packed with lock nut (12). The said hub having a flange (15) carries wheel bolt (2) which provides seating for brake drum (1) and wheel rim and tightened with the use of wheel nut (3). The said hub (4) is formed by casting having central portion (17), which is the main portion of hub (4). The invention involves providing hexagonal shape to the central portion instead of circular shape of said hub. This makes hub 10% more strength to carry the various loads (i.e. vehicle GVW, cornering, braking & torque load) during different operating conditions of the wheel. Further a small hexagon formed on the each side of the said central hexagonal hub at outer half section peripheral. The said small hexagon outer half section of the peripheral intersects with central hexagon (17). The inner half portion of the hexagon (18) merges with central hexagon section (17). The intersecting hexagon edge (21) is so arranged that the two sides of the said small hexagon are parallel to central hexagon from two sides (22) respectively. The smaller hexagon (18) joins the central hexagon (17) with hub flange (15), giving the required strength and stiffness as shown in FIGS. 1 and 3.

The technical advantages of the present invention are:
Polygonal (particularly hexagonal/honeycomb) structure of the hub has more load caring capacity used as main structural part of hub (like honeycomb design used by honeybee);
The major load line area section is used of hexagonal shape which is stronger than same size of circular section with optimum material content;
The intersecting smaller hexagons with major central hexagons, which is creating mesh like structure increases the system stiffness with significant reduction in stress levels
Direct reaction to the load and stresses are minimized due to the presence of robust structural feature (side of hexagon) exactly in the direction of load;
The intersecting hexagons form fin like structures which serve as heat dissipation media (i.e. More surface area) increasing the seal and grease life under severe operating conditions like desert, high speed, etc.

The hexagonal hub of the present invention can be used for variety of vehicles such as transportation vehicles like truck, buses, two wheelers, cars and also for farm equipments. The possible combinations of polygons to have polygonal hub structure are:
Central hexagon structure with 6 intersecting hexagons
Central hexagon structure with 3 intersecting hexagons
Central Octagon structure with 8 intersecting hexagons
Central Octagon structure with 4 intersecting hexagons

It is to be understood that the present invention is not limited in its application to the details of the construction and to the arrangements of the components as mentioned in the above description or illustrated in the drawings. The invention is capable of other embodiments and of being practiced and carried out in various ways. Also, the terminologies used herein are for the purpose of description and should not be regarded as limiting.

1. A polygonal hub for fully floating rear drive axle of a vehicle used in the break drum and wheel assembly comprising: a hub which rotates on the supporting member of an axle drive shaft assembled with inner bearing and outer bearing in the housing therein with seals lubricants to enable the hub to rotate freely about an axis and are fixed in position with said supporting member; the complete wheel end assembly then packed with lock nut; the said hub having a flange carries wheel bolt which provides seating for brake drum and wheel rim and tightened with the use of a wheel nut; the said hub is formed by casting having a central portion, which is the main portion of hub, wherein the said central portion is made of hexagonal in shape to carry safely the various loads during different operating conditions of the wheel.

2. A polygonal hub for fully floating rear drive axle of a vehicle as claimed in claim 1, wherein a small hexagon formed on the each side of the said central hexagonal hub at outer half section peripheral such that the said small hexagon outer half section of the peripheral intersects with central hexagon and the inner half portion of the hexagon merges with central hexagon section in such a way that the intersecting hexagon edge is so arranged that the two sides of the said small hexagon are parallel to central hexagon from two sides respectively and the smaller hexagon joins the central hexagon with hub flange giving the required strength and stiffness.
